(19) United States
(12) Patent Application Publication
(10) Pub. No.: US 2003/0061340 A1
(43) Pub. Date: Mar. 27, 2003

(54) Network health monitoring through real-time analysis of heartbeat patterns from distributed agents

(76) Inventors: Mingqiu Sun, Beaverton, OR (US); Jeffrey A. Tonn, Aloha, OR (US)

Correspondence Address: PILLSBURY WINTHROP, LLP, P.O. BOX 10500, MCLEAN, VA, 22102, US

(21) Appl. No.: 09/961,397

(22) Filed: Sep. 25, 2001

(51) Int. Cl. G06F 15/173

(52) U.S. Cl. 709/224; 714/47

(57) ABSTRACT

An arrangement is provided for monitoring network health. A plurality of distributed agents are deployed in different segments of a network. The distributed agents send heartbeat signals to a network health monitoring mechanism. Upon receiving the hearbeat signals from the agents, the network health monitoring mechanism determines the health of the network based on the deviation of the received heartbeat signals from baseline patterns.

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

Aspects of the present invention relate to computer network. Other aspects of the present invention relate to network management.

In Internet data centers and modem enterprises, it is not uncommon to deploy large, highly complex, and segmented networks of computing devices, in which localized traffic flows from subnet to subnet. It has become increasingly difficult to monitor such networks and respond to unexpected events. Typically, 90 to 95 percent of undesirable network events occur without network management's awareness.

The challenge for network management professionals is to understand what constitutes the health of a complex network and to be able to pin point the root causes of observed irregularities in the network before such an irregularity grows into a problem that causes a complete network outage. Network monitoring tools are available that detect network “blackout” when network components become completely inoperable. However, these tools fail to detect “brownout”, during which performance-impacting events occur gradually with no abrupt individual network component failure.

One common approach to identify root causes of such performance-impacting events is to set up network protocol analysis devices in selected segments to record localized traffic for offline analysis. Such approach usually does not work well because of the amount of data collected and the lack of capability of interpreting massively collected raw data. In addition, it is often cost prohibitive to monitor different segments of a large network using expensive protocol analysis devices.

### BRIEF DESCRIPTION OF THE DRAWINGS

The inventions claimed and described herein will be further disclosed by describing various exemplary embodiments in detail with reference to the drawings. These embodiments are non-limiting exemplary embodiments, in which like reference numerals represent similar parts throughout the several views of the drawings, and wherein:

FIG. 1 depicts a mechanism in which network health is monitored through analyzing the heartbeats sent from distributed heartbeat agents with respect to baseline patterns;

FIG. 2 is an exemplary flowchart of a process, in which heartbeats are transmitted from distributed heartbeat agents and are used to determine network health with respect to baseline patterns;

FIG. 3 depicts the internal structure of a network health monitoring mechanism, in relation to a plurality of distributed heartbeat agents;

FIG. 4 depicts the internal structure of a distributed heartbeat agent;

FIG. 5 is an exemplary flowchart of a process, in which a distributed heartbeat agent periodically generates and transmits heartbeat signals;

FIG. 6 shows exemplary comparison between a baseline pattern and the pattern formed from heartbeat signals;

FIG. 7 depicts the internal structure of a heartbeat analysis mechanism; and

FIG. 8 is an exemplary flowchart of a process, in which a network monitoring mechanism determines the health of a network based on received heartbeat signals and the baseline patterns.

### DETAILED DESCRIPTION

The inventions are described below, with reference to detailed illustrative embodiments. It will be apparent that the invention can be embodied in a wide variety of forms, some of which may be quite different from those described in this document. Consequently, the specific structural and functional details disclosed herein are merely representative and do not limit the scope of the invention.

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

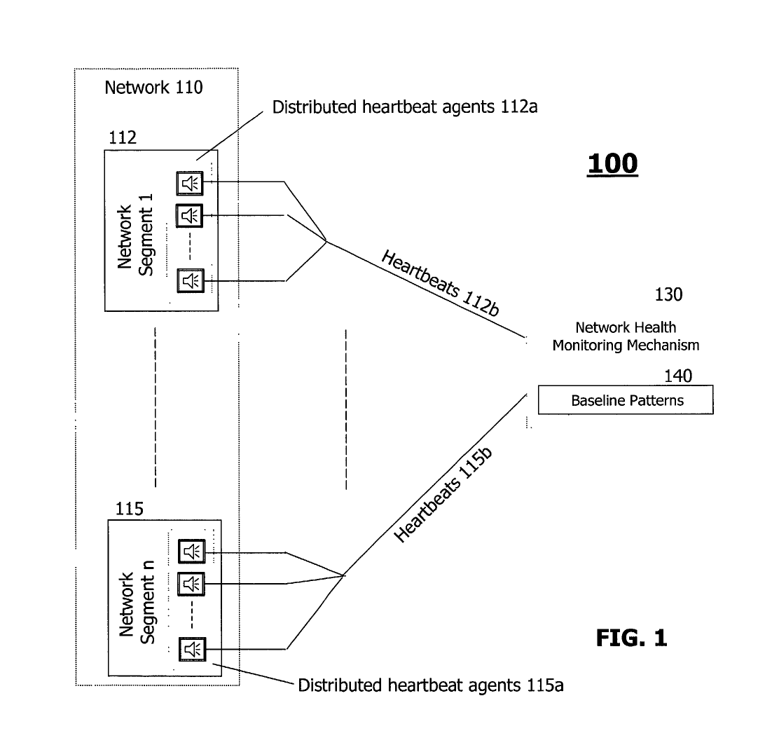

FIG. 1 depicts a mechanism 100 in which a network monitoring mechanism 130 monitors the health of network 110 by analyzing the heartbeats 112b, . . . , 115b, sent from a plurality groups of heartbeat agents 112a, . . . , 115a that are distributed in the network 110, with respect to baseline patterns 140, representing normal network health. The network 110 may comprise a plurality of segments 112, . . . , 115, each of which may deploy a corresponding group of heartbeat agents that periodically send the heartbeats 112b, . . , 115b to the network health monitoring mechanism 130.

The network 110 may represent a generic network such as the Internet, a wireless network, or a proprietary network. It may be divided into a plurality of segments according to some criteria. The network 110 may be partitioned, for instance, according to the traffic flow patterns. In this case, the network segments 112, . . , 115 may be created so that the bilateral traffic flows among different segments is minimized.

A heartbeat agent may correspond to a lightweight and operational mechanism located in a segment of the network 110 to be monitored. A heartbeat agent is responsible for periodically generating and transmitting heartbeat signals according to some pre-determined specification. For example, a heartbeat signal may be pre-defined to include an Internet Protocol (IP) address and a timestamp recording the precise time by which the heartbeat signal is sent. In this case, the IP address may represent the routable address of, for instance, the device on which the heartbeat agent resides. The content of a heartbeat signal and the periodicity according to which the heartbeat signals are sent may be configured prior to the deployment of a heartbeat agent. Such a configuration may also be updated when such a need arises.

Heartbeat agents may be distributed in such a way that the health of different segment of the network 110 can be properly monitored. This may involve the number of heartbeat agents deployed in a particular segment and where these heartbeat agents should be located in the segment. Such decisions may be made according to the traffic load pattern of the underlying network segments. For example, if a particular segment of the network 110 usually has high volume of traffic, more heartbeat agents may be deployed and distributed densely.

According to the mechanism 100, the network health monitoring mechanism 130 determines the network health based on the deviation of the network performance measured based on the received heartbeats 112b, . . . , 115b from the baseline patterns 140. The baseline patterns 140 may characterize normal network health with respect to various network health measurements. For example, a network latency baseline pattern may characterize the normal network latency in the form of a distribution function.

A baseline pattern may be created based on heartbeat signals received under normal or healthy network conditions. For example, a latency baseline distribution may be derived from the latencies measured from the heartbeat signals received under normal (or healthy) network conditions. Using a series of heartbeat signals received under healthy network conditions, various statistics can also be extracted to characterize healthy or expected behavior of the network 110. For instance, an average latency may be computed based on all the heartbeat signals received under normal conditions.

A plurality of baseline patterns may be established with respect to different measures of network performance. Collectively, these baseline patterns are used to describe the overall characteristics of a healthy network. For example, a baseline pattern may be established with respect to both network latency and packet loss. Such a baseline pattern forms a multi-dimensional distribution, characterizing healthy network behavior with respect to latency and packet loss. Baseline patterns may also be established with respect to individual network segments instead of with respect to the entire network. The segmented baseline patterns may be adopted when the network 110 covers a large area and each area may present different characteristics.

The baseline patterns 140 indicates expected (healthy) network behavior. In other words, significant deviation from such expected network behavior can be considered as unhealthy. The network health monitoring mechanism 130 monitors the health of the network 110 by comparing the received heartbeats 112b, . . . , 115b with the baseline patterns 140 and determines the network health according to the deviation of the received heartbeats from the baseline patterns 140. When segmented baseline patterns are employed, the segments from where the heartbeat signals are received may be identified and such identification may be used to retrieve appropriate baseline patterns.

A plurality of network health monitoring mechanism 130 may be deployed (not shown in FIG. 1). That is, the mechanism 100 may be duplicated. Multiple network health monitoring mechanisms may be distributed and each may be responsible for monitoring a sub network consisting of multiple segments. Different network health monitoring mechanisms may communicate with each other and collaborate to monitor the health of the network 110.

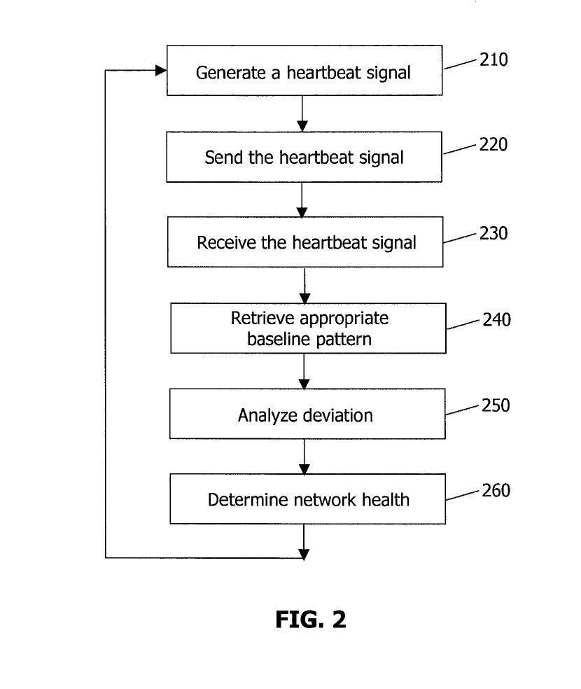

FIG. 2 is an exemplary flowchart of a process, in which a plurality of heartbeat agents, distributed in the network 110, send heartbeats to a network health monitoring mechanism which subsequently determines the health of the network 110 based on the received heartbeats and the baseline patterns 140. A heartbeat signal is first generated at act 210 according to some pre-specified criteria. Such generated heartbeat signal is then sent, at act 220, from the heartbeat agent to the network health monitoring mechanism 130.

Upon receiving the heartbeat at act 230, the network health monitoring mechanism 130 retrieves, at act 240, appropriate baseline patterns. Different measurements made based on the received heartbeat signals (e.g., latency measured based on the timestamp carried in the received heartbeat signals) are compared with the retrieved baseline patterns. Deviations are detected and analyzed, at act 250, with respect to the baseline patterns. Such deviation is then used to determine, at act 260, the health of the operating network.

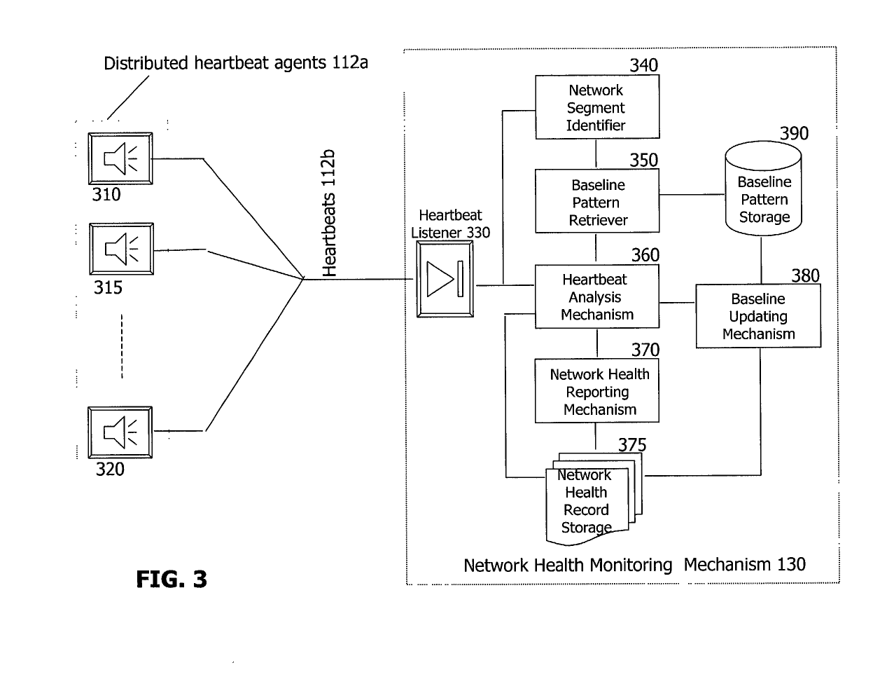

FIG. 3 depicts the internal structure of the network health monitoring mechanism 130, in relation to, as an example, the group 112a of distributed heartbeat agents. The heartbeat agents 310, 315, . . . , 320 in the group 112a send heartbeat signals 112b to the network health monitoring mechanism 130. Each of the heartbeat agents may work independently in an asynchronous fashion, transmitting heartbeat signals. They may also work in a synchronous fashion, sending heartbeat signals according to some universal clock.

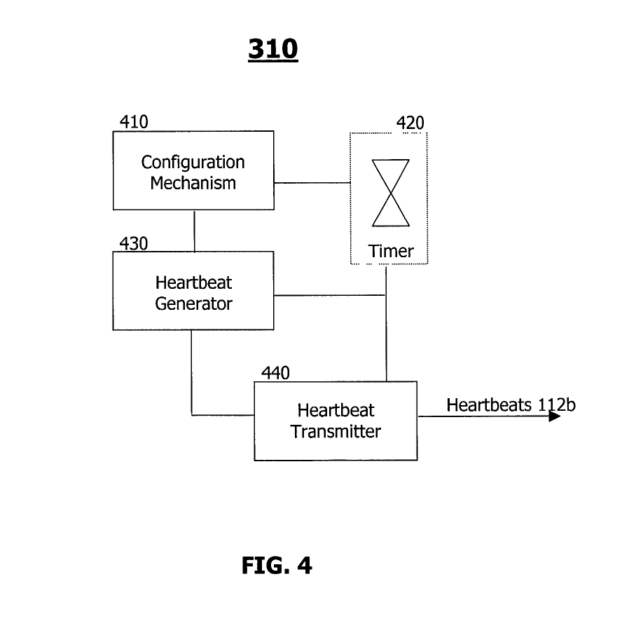

FIG. 4 depicts an exemplary internal structure of a distributed heartbeat agent (e.g., 310), which comprises a configuration mechanism 410, a timer 420, a heartbeat generator 430, and a heartbeat transmitter 440. The heartbeat generator 430 generates a heartbeat signal according to some predetermined setting or configuration, which may involve the periodicity of the heartbeat signals and the content each heartbeat signal should contain. For example, it may be specified that a heartbeat signal should be issued every 10 seconds and sent with an IP address and a timestamp. The heartbeat generator 430 connects to the configuration mechanism 410, which provides the specification in terms of the content of a heartbeat signal, and the timer 420, which controls the periodicity of the heartbeat signals.

The configuration mechanism 410 facilitates the configuration of a heartbeat agent. The initial setting may be provided when the heartbeat agent 310 is deployed. The configuration may include the specification about the content that a heartbeat signal should contain and the periodicity of heartbeat signals. The specified periodicity may correspond to a regular periodicity (e.g., every 2 second) or an irregular periodicity (e.g., every 2 second when traffic is not heavy and every 1 second when the traffic is heavy). Such setting may also be updated whenever such needs arise. For example, when the underlying segment of the network 110 is upgraded, the periodicity of the heartbeat signals issued from the segment may need to be increased. The heartbeat transmitter 440 sends a heartbeat signal to the network health monitoring mechanism 130. The transmission may also be performed under the control of the timer 420.

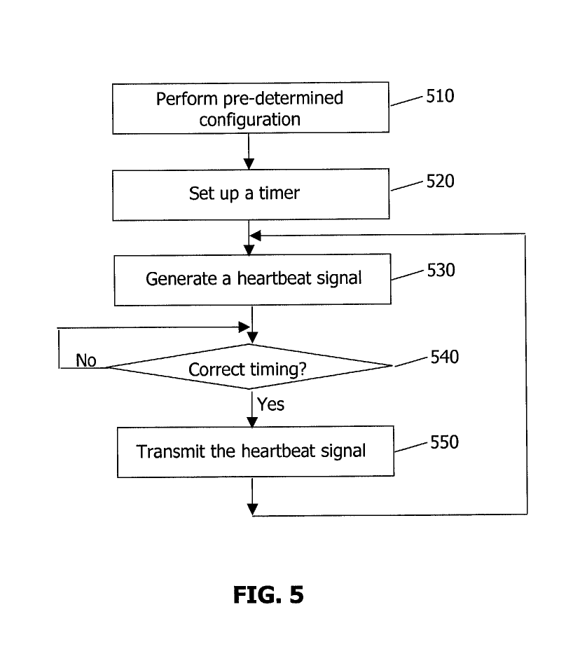

FIG. 5 is an exemplary flowchart of a process, in which a distributed heartbeat agent periodically generates and transmits heartbeat signals. Pre-determined configuration that specifies the content and the periodicity of a heartbeat signal is first performed at act 510. A timer is subsequently set up, at act 520, according to the specified periodicity. The heartbeat generator 430 generates, at act 530, a heartbeat signal based on the predetermined configuration. The generated heartbeat signal is then fed to the heartbeat transmitter for transmission. The timing is examined, at act 540, to ensure that the transmission timing is consistent with the pre-determined periodicity. If the timing is consistent with the predetermined periodicity, the heartbeat signal is sent, at act 550, to the network health monitoring mechanism 130.

Referring again to FIG. 3, the network health monitoring mechanism 130 comprises a heartbeat listener 330, a network segment identifier 340, a baseline pattern retriever 350, a heartbeat analysis mechanism 360, a network health reporting mechanism 370, a network health record storage 375, a baseline updating mechanism 380, and a baseline pattern storage 390.

The heartbeat listener 330 listens to and intercepts the heartbeats sent from each and every heartbeat agent deployed in the network 110. It may be implemented as either a synchronous or an asynchronous mechanism. Based on an intercepted heartbeat signal, the network segment identifier 340 identifies the network segment associated with the source of the heartbeat signal. Such identification may be necessary to assist the network health monitoring mechanism 130 to pin point an unhealthy segment in the network 110. In addition, a segment identifier may be needed to retrieve appropriate baseline patterns corresponding to the segment from the baseline pattern storage 390. As discussed earlier, the baseline patterns 140 may be established with respect to individual segments of the network 110. In this case, appropriate baseline patterns are retrieved according to where the heartbeat signals come from.

The baseline pattern retriever 350 accesses the baseline pattern storage 390 and obtains appropriate baseline patterns. The retrieved baseline patterns 140 are fed, together with the heartbeat signals (intercepted by the heartbeat listener 330), to the heartbeat analysis mechanism 360, where the deviation of the received heartbeat signals from the baseline patterns is analyzed.

Based on the deviation information, the heartbeat analysis mechanism 360 determines whether the corresponding segment of the network 110 is healthy. If the heartbeat analysis mechanism 360 decides that the network 110 is healthy, related information extracted from the received heartbeat signals may be fed to the baseline updating mechanism 380 that dynamically updates the baseline patterns. In this way, the baseline patterns 140 is adaptive to the dynamics of a normal and healthy network. For example, when a segment of the network 110 is upgraded so that the network latency from that segment is in general reduced, such a reduction needs to be incorporated into corresponding baseline patterns 140 to correctly characterize the expected network behavior.

When the heartbeat analysis mechanism 360 decides that the received heartbeat signals constitute unhealthy network behavior, it activates the network health reporting mechanism 370 to caution the network management. For example, the network health reporting mechanism 370 may prompt, on a console, network managers about the unhealthy behavior of the network 110. It may also send emails or make phone calls to responsible personnel.

The detected network behavior, either healthy or unhealthy, may also be properly logged in the network healthy record storage 375. Such recorded health history may be used in helping the heartbeat analysis mechanism 360 to determine the near future health of the network 110. For example, if the heartbeat signals received in the last 10 minutes, although not yet constituting an unhealthy network performance, coupled with currently received heartbeat signals, form a trend of degraded network performance (e.g., gradually increasing network latency), the heartbeat analysis mechanism 360 may be able to rely on such trend, detected using the recorded history data, to predict the future health of the network 110. For instance, it may be possible to estimate, according to a detected trend, a future time by which the network performance becomes unacceptable (i.e., the network is not healthy).

The recorded network health information may also be used by the baseline updating mechanism 360 to determine how to update the baseline patterns. For instance, if network latency in the last two days have kept low and stable relative to the existing baseline latency pattern, the existing baseline latency pattern may need to be revised to reflect such change (e,g., the lower network latency may be due to the upgrade performed recently on the network 110).

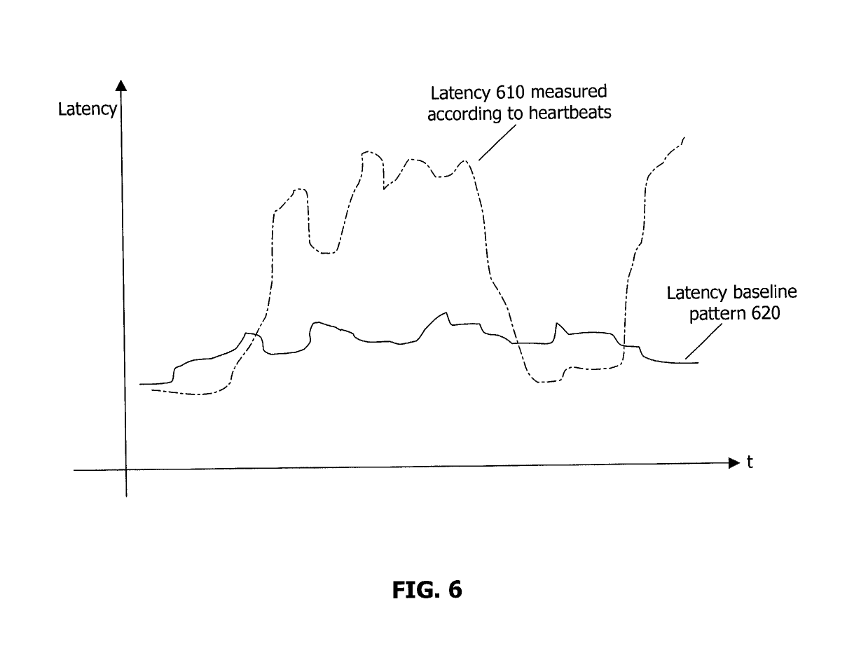

The heartbeat analysis mechanism 360 is an essential part of the network health monitoring mechanism 130. It detects the deviation in different aspects of the deviation and then determines whether the underlying segment of the network 110 (from where the heartbeat signals are received) is healthy. FIG. 6 illustrates an exemplary deviation between a baseline pattern 620, established with respect to network latency, and a signal pattern 610, constructed based on the latencies measured from received heartbeat signals. The latency baseline pattern 620 illustrates a stable behavior with a fairly flat curve. The latency pattern 610 measured from received heartbeat signals presents a significant deviation from the expected curve 620 with fluctuations over time. The deviation between two curves 610 and 620 may be characterized according to two different aspects. One is that the curve 610 displays much higher latency than the expected normal latency 620. Another aspect of the deviation may be that the latency measured from the heartbeat signals does not seem to be as stable as expected.

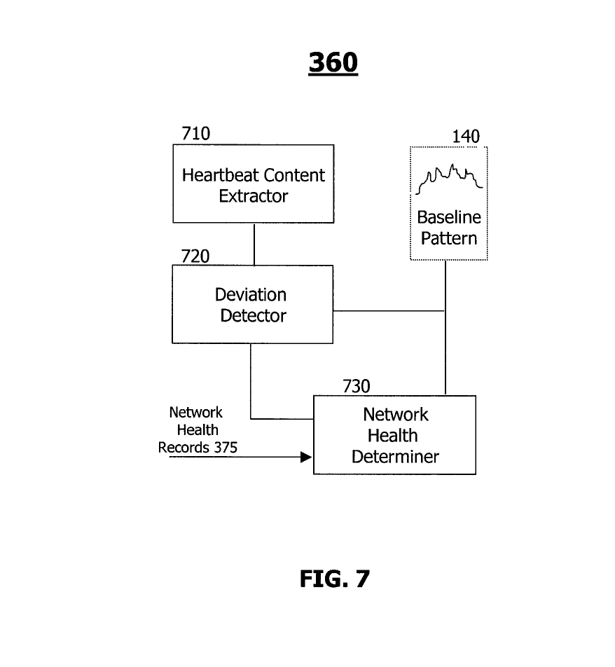

The heartbeat analysis mechanism 360 may perform different acts in order to determine the deviation and consequently the health status of the network 110. FIG. 7 depicts an exemplary internal structure of the heartbeat analysis mechanism 360, which comprises a heartbeat content extractor 710, a deviation detector 720, and a network health determiner 730. The heartbeat content extractor 710 identifies useful information sent along with a heartbeat signal. For example, the timestamp may be extracted which marks the precise time by which the heartbeat signal is sent. Based on the extracted content, measures that may be used in determining the deviation can be computed. For instance, based on the extracted timestamp, latency may be computed based on the difference between the time the signal is sent and the time the signal is received.

The computed measures are fed, together with an appropriate baseline pattern, to the deviation detector 720, where the difference between the measures, made based on the received heartbeat signals, and the expected measures, represented by the baseline pattern, is detected. Based on such on-line detected deviation and the network health records 375, the network health determiner decides the network health. Different decision making strategies or criteria may be implemented in the network health determiner 730. The adopted strategies may be application dependent. For example, different service level agreement (SLA) may necessarily lead to different criteria in detecting abnormal behavior of the network 110.

The network health determiner 730 may employ existing pattern recognition techniques to carry out the decision making. For instance, statistical approaches can be used to determine whether the two curves (e.g., curve 610 and curve 620 shown in FIG. 6, one is from baseline patterns and the other is from received heartbeat signals) are significantly different or are actually from two different underlying distributions.

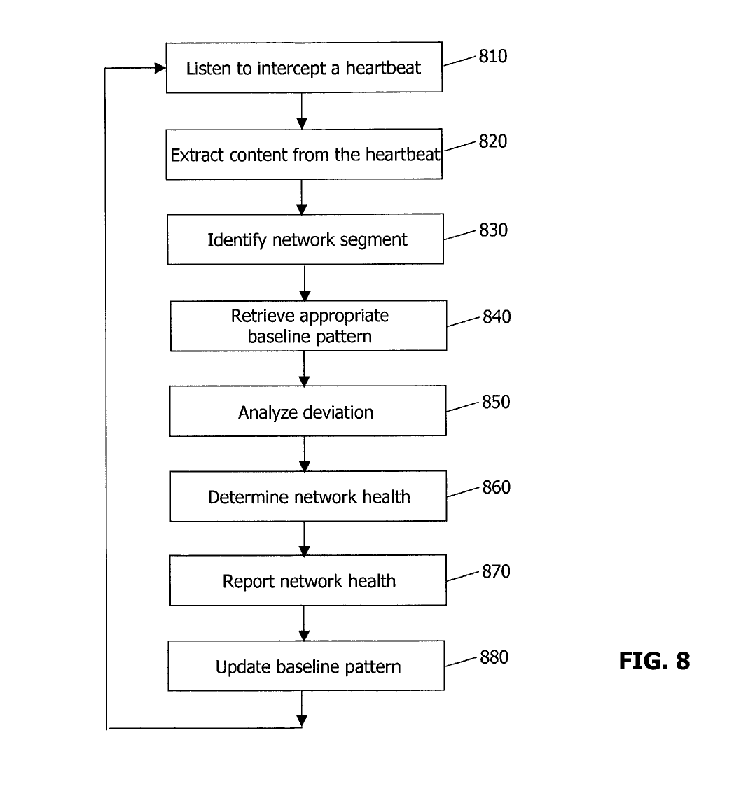

FIG. 8 is an exemplary flowchart of a process, in which the network monitoring mechanism 130 determines the health of a network based on received heartbeat signals and baseline patterns. The heartbeat listener 330 first listens and intercepts, at act 810, a heartbeat signal. Useful content is then extracted, at act 820, from the received heartbeat signal. The segment of the network 110, from where the heartbeat signal is sent is identified at act 830.

Using identified segment information, appropriate baseline patterns are retrieved at act 840. Based on the content extracted from the received heartbeat signal and the retrieved baseline patterns, the deviation between the current network behavior, measured from the heartbeat signal, and the expected network behavior is analyzed at act 850. The network health is subsequently determined, at act 860, based on the deviation. The network health is reported at act 870 and the decision about the network health, together with the network performance measures, are logged. Using the dynamic information about the network health, the baseline patterns are updated at act 880.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and, materials, such as are within the scope of the appended claims.

What is claimed is:

1. A method, comprising:
sending, from a distributed agent located in a segment of a network to a network health monitoring mechanism, a heartbeat signal;
receiving, by the network health monitoring mechanism, the heartbeat signal; and
determining the health of the segment of the network according to the deviation of the heartbeat signal from a baseline pattern.

2. The method according to claim 1, wherein the sending the heartbeat signal comprises:
generating the heartbeat signal according to a pre-determined configuration; and
transmitting the heartbeat signal according to a pre-configured timing.

3. The method according to claim 1, wherein the determining the health comprises:
extracting, by the network health monitoring mechanism, content from the heartbeat signal, received by the receiving;
retrieving the baseline pattern;
analyzing the deviation between the heartbeat signal and the baseline pattern; and
verifying the health of the segment of the network based on the deviation.

4. A method for a distributed agent, comprising:
generating a heartbeat signal containing content specified by a pre-determined configuration; and
transmitting the heartbeat signal according to a timing.

5. The method according to claim 4, further comprising:
performing the pre-determined configuration; and
setting up a timer that controls the timing of the transmitting.

6. A method for monitoring network health, comprising:
receiving a heartbeat signal from a distributed agent located in a segment of a network; and
determining the health of the segment of the network based on the deviation of the heartbeat signal from a baseline pattern.

7. The method according to claim 6, wherein the receiving a heartbeat signal comprises:
listening to the distributed agent; and
intercepting the heartbeat signal when the distributed agent sends the heartbeat signal.

8. The method according to claim 6, wherein the determining the health comprises:
extracting content from the heartbeat signal, received by the receiving;
retrieving the baseline pattern;
analyzing the deviation between the heartbeat signal and the baseline pattern; and
verifying the health of the segment of the network based on the deviation.

9. The method according to claim 8, further comprising:
identifying, prior to the retrieving, the segment of the network based on received heartbeat signal;
reporting the health of the segment of the network based on the result from the verifying; and
updating the baseline pattern based on the deviation.

10. A system, comprising:
a plurality sets of agents distributed in a network for sending heartbeat signals, wherein each set of agents is located within a segment of the network;
a network health monitoring mechanism for monitoring the health of different segments of the network based on the deviation between the heartbeat signals, received from the agents located in the segments, and one or more baseline patterns representing the normal health of the network.

11. The system according to claim 10, wherein each of the agents comprises:
a heartbeat signal generator for generating a heartbeat signal containing content specified by a pre-determined configuration;
a timer for controlling the timing of transmitting the heartbeat signal; and
a heartbeat transmitter for transmitting the heartbeat signal according to the timing specified by the timer.

12. The system according to claim 11, further comprising:
a configuration mechanism for performing the pre-determined configuration and for setting up the timer.

13. The system according to claim 10, wherein the network health monitoring mechanism comprises:
a heartbeat listener for listening to the plurality sets of agents and for receiving a heartbeat signal from a distributed agent located in a segment of the network; and
a heartbeat analysis mechanism for determining the health of the segment of the network based on the deviation of the heartbeat signal from a baseline pattern.

14. The system according to claim 13, further comprising:
a network health reporting mechanism for reporting and recording the information related to the health of the network.

15. A system for an agent, comprising:
a heartbeat signal generator for generating a heartbeat signal containing content specified by a pre-determined configuration;
a timer for controlling the timing of transmitting the heartbeat signal; and
a heartbeat transmitter for transmitting the heartbeat signal according to the timing specified by the timer.

16. The system according to claim 15, further comprising:
a configuration mechanism for performing the pre-determined configuration and for setting up the timer.

17. A network health monitoring mechanism, comprising:
a heartbeat listener for listening to a plurality sets of agents, distributed in at least one segment of a network, and for receiving a heartbeat signal from a distributed agent located in a segment of the network; and
a heartbeat analysis mechanism for determining the health of the segment of the network based on the deviation of the heartbeat signal from a baseline pattern.

18. The mechanism according to claim 17, wherein the heartbeat analysis mechanism comprises:
a heartbeat content extractor for extracting content from the heartbeat signal;
a deviation detector for detecting the deviation between the heartbeat signal and the baseline pattern; and
a network health determiner for determining the health of the segment of the network based on the deviation.

19. The mechanism according to claim 18, further comprising:
a network segment identifier for identifying the segment from where the heartbeat signal is received;
a baseline pattern retriever for retrieving the baseline pattern corresponding to the segment of the network; and
a network health reporting mechanism for reporting and recording the information related to the health of the network.

20. The mechanism according to claim 19, further comprising:
a baseline updating mechanism for updating the baseline pattern based on the deviation and the information related to the health of the network.

21. A computer-readable medium encoded with a program, the program, when executed, causing:
sending, from a distributed agent located in a segment of a network to a network health monitoring mechanism, a heartbeat signal;
receiving, by the network health monitoring mechanism, the heartbeat signal; and
determining the health of the segment of the network according to the deviation of the heartbeat signal from a baseline pattern.

22. The medium according to claim 21, wherein the sending the heartbeat signal comprises:
generating the heartbeat signal according to a pre-determined configuration; and
transmitting the heartbeat signal according to a pre-configured timing.

23. The medium according to claim 21, wherein the determining the health comprises:
extracting, by the network health monitoring mechanism, content from the heartbeat signal, received by the receiving;
retrieving the baseline pattern;
analyzing the deviation between the heartbeat signal and the baseline pattern; and
verifying the health of the segment of the network based on the deviation.

24. A computer-readable medium encoded with a program for a distributed agent, the program, when executed, causing:
generating a heartbeat signal containing content specified by a pre-determined configuration; and
transmitting the heartbeat signal according to a timing.

25. The medium according to claim 24, the program, when executed, further causing:
performing the pre-determined configuration; and
setting up a timer that controls the timing of the transmitting.

26. A computer-readable medium, encoded with a program for monitoring network health, the program, when executed, causing:
receiving a heartbeat signal from a distributed agent located in a segment of a network; and
determining the health of the segment of the network based on the deviation of the heartbeat signal from a baseline pattern.

27. The medium according to claim 26, wherein the receiving a heartbeat signal comprises:
listening to the distributed agent; and
intercepting the heartbeat signal when the distributed agent sends the heartbeat signal.

28. The medium according to claim 26, wherein the determining the health comprises:
extracting content from the heartbeat signal, received by the receiving;
retrieving the baseline pattern;
analyzing the deviation between the heartbeat signal and the baseline pattern; and
verifying the health of the segment of the network based on the deviation.

29. The medium according to claim 28, the program, when executed, further causing:
identifying, prior to the retrieving, the segment of the network based on received heartbeat signal;
reporting the health of the segment of the network based on the result from the verifying; and
updating the baseline pattern based on the deviation.
